(19) United States
(12) Patent Application Publication
(10) Pub. No.: US 2014/0346128 A1
(43) Pub. Date: Nov. 27, 2014

(54) Tree Planter Harness

(71) Applicant: John Joseph Peterson, Paramus, NJ (US)

(72) Inventor: John Joseph Peterson, Paramus, NJ (US)

(21) Appl. No.: 14/454,941

(22) Filed: Aug. 8, 2014

Related U.S. Application Data
(63) Continuation of application No. 13/729,028, filed on Dec. 28, 2012.

(51) Int. Cl. A47B 81/00; F16M 13/02

(52) U.S. Cl. CPC A47B 81/00; F16M 13/02
USPC 211/71.01; 248/219.4

(57) ABSTRACT

The tree planter harness supports and holds in an elevated or ground level position a planter or planters around and adjacent to the circumference of an upright tree trunk for the purpose of growing and/or retaining plants.

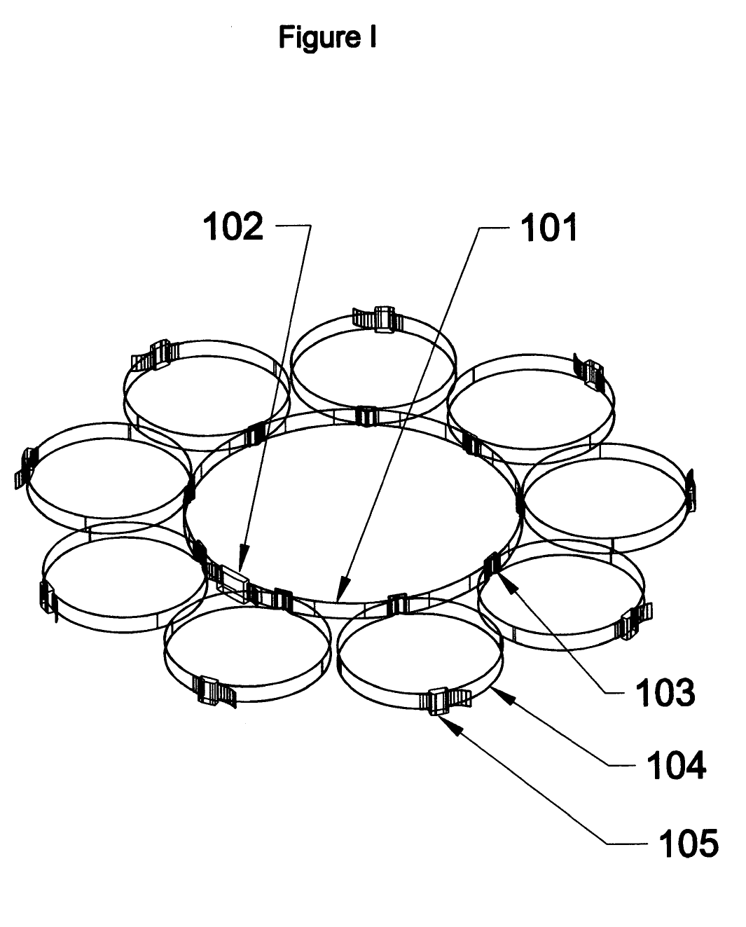

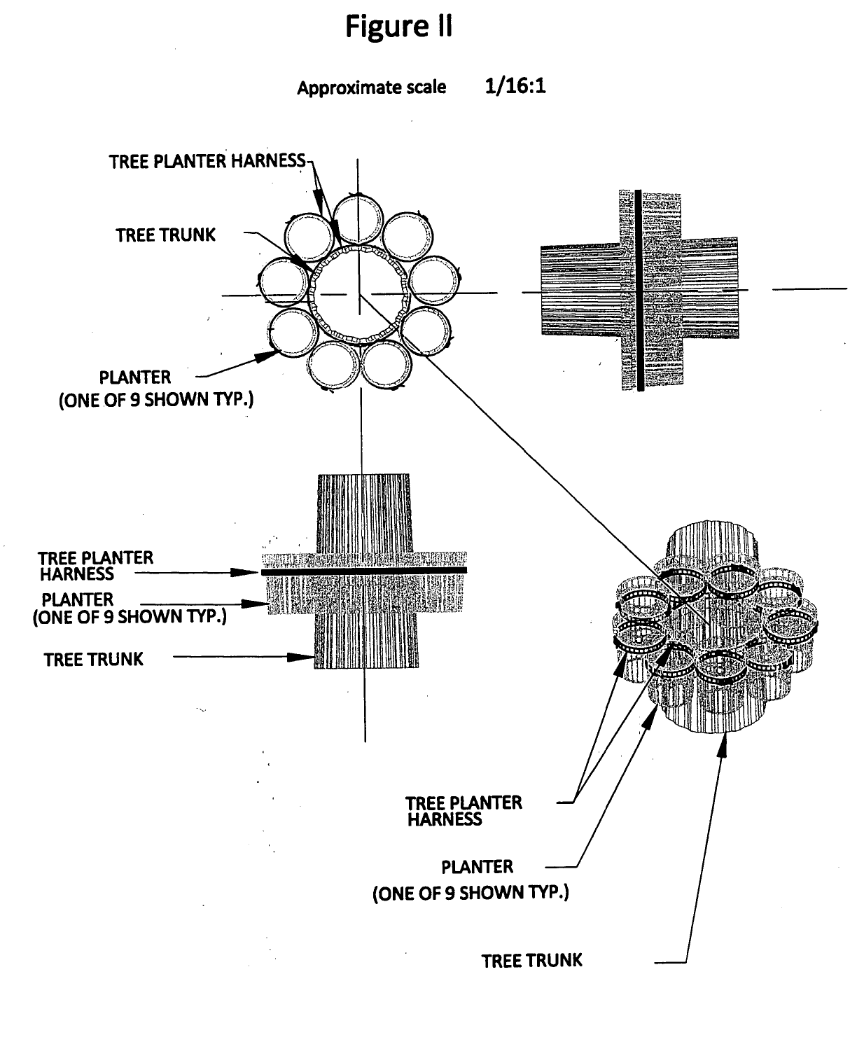

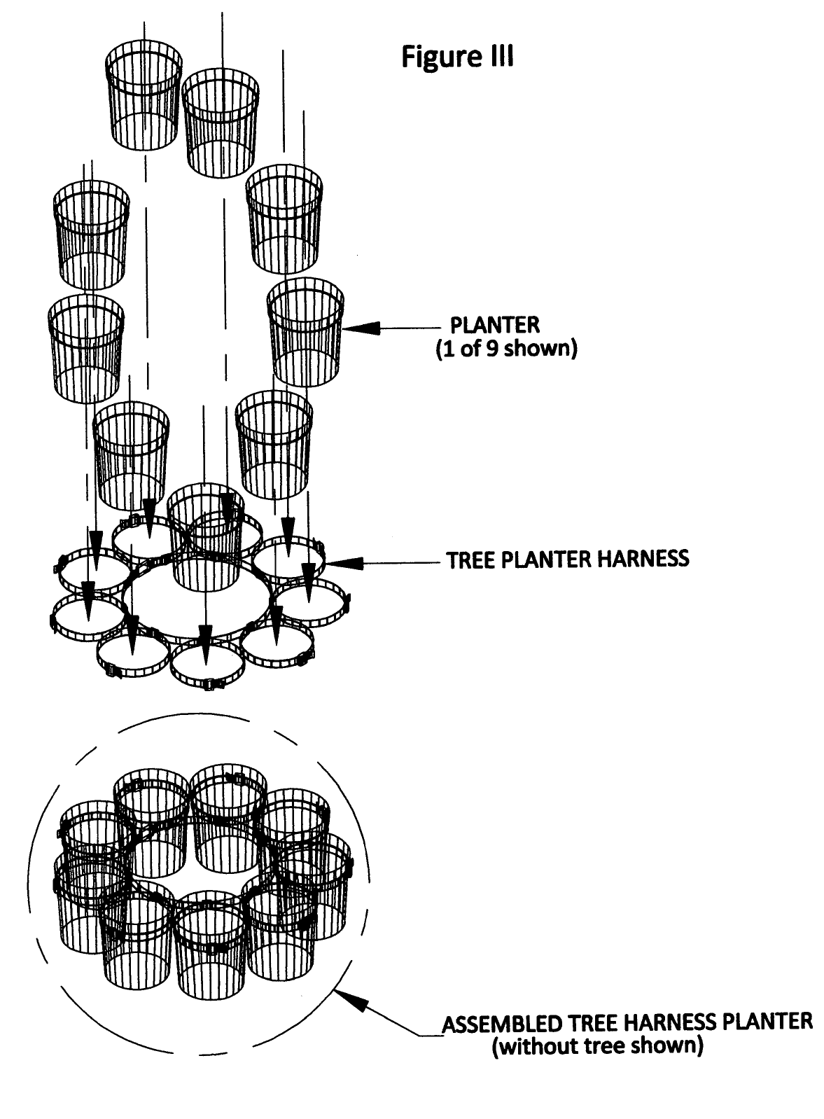

### CROSS-REFERENCE TO RELATED APPLICATIONS

This application is a continuation application of U.S. application Ser. No. 13/729,028 filed on Dec. 28, 2012 which claims priority to U.S. Application 61/580,985 filed on Dec. 28, 2011, the contents of both of which are herein fully incorporated by reference in their entirety.

### BACKGROUND OF THE INVENTION

### Brief Summary of the Invention

The Tree Planter Harness is an apparatus which supports and holds in an elevated or ground level position a planter or planters around the circumference of an upright tree trunk for the purpose of growing or retaining plants. The harness utilizes a flexible belt like material to hold and retain the apparatus in place. The natural non conformances and natural growth taper of tree trunk (larger at the bottom and tapering smaller as the tree progresses upward)prevents the harness from falling or slipping downward thus retaining the harness in place on the tree trunk. The sub components of the harness shown as retaining harnesses retain the planters in a vertical position. The main harness and retaining harnesses are adjustable to be receptive to many sizes and shapes of tree trunks and planters. The retaining harnesses may or may not be used if a planter has a provision to support itself to the main harness.

### BRIEF DESCRIPTION OF THE SEVERAL VIEWS OF THE FIGURES

Figure I is an auxiliary view of the harness and the subcomponents.

Figure II is an auxiliary view of a tree trunk with the tree planter harness and the tree planter harness subcomponents.

Figure III is an assembly drawing of the planters and harness along with totally assembled harness with planters.

### DETAILED DESCRIPTION OF THE INVENTION

The Tree Planter Harness is an apparatus which supports and holds in an elevated position a planter or planters around the circumference of an upright tree trunk for the purpose of growing or retaining plants.

The Main Support Harness (101) purpose is to support and hold in position the planters via the planter retaining harness (104) or harnesses around the circumference of an upright tree trunk. The planter retaining harness, support and retain planters in an elevated position or at ground level around the circumference of an upright tree trunk or trunks. The Planter retaining harness may not be used if the planter has been made or adapted to be retained by the main support harness. The planters are used to grow plants, flowers and such or to hold artificial ornaments or plants.

The Main Support Harness 101 is constructed of an open ended flexible belt, belt like, strap or strap like material and an adjustment connecting fastener 102, which will allow the two open ends to be connected to each other after both ends encompass a tree trunks diameter thus creating one complete closed adjustable loop. The adjustment in the loop size (Diameter) which can be made larger or smaller is necessary to accommodate a wide variety of tree trunk diameters. Two or more main support harnesses may be linked together to accommodate larger tree diameters.

The main Support Harness is positioned around a tree trunks diameter by encompassing one opened end of the harness to the left side of the tree trunk diameter and encompassing the other open end of the harness to the right side of the tree trunk diameter, the two open ends are connected together (using the fastener) around the tree truck thus creating a complete enclosed harness loop surrounding the tree trunk diameter. The tension of the harness is adjusted in the direction of the tightening position against the diameter of the tree trunk. The tightened harness is not only relying upon the tension of the harness against the tree trunk diameter but also utilizes the natural non-conformances of the tree trunk as well as the natural growth taper of the tree trunk as being larger towards the bottom and naturally and slowly tapers narrower moving upward on the tree trunk, thus supporting itself from falling downward The Main Support Harness's length or when the two ends are connected diameter is made adjustable via the connecting and adjustment fastener and or a hook and loop fastener (Velcro).

The Main Support Harness 101 retains other secondary components called the Planter Retaining Harness. The Planter Retaining Harness 104 or harnesses 104 are attached to the main support harness 101 either permanently or made detachable.

The Planter Retaining Harness or Harnesses 104 is constructed of a flexible belt, belt like, strap or strap like material and is adjustable via 105 an adjustment fastener and or a hook and loop material (Velcro®) unless otherwise constructed to a fixed size or diameter when called for on special production applications. The Planter Retaining Harness is flexible and adjustable similar to a waste line belt thus the area in the center area (the loop)of the Planter Retaining Harness can be adjusted to be smaller or larger, this adjustment is achieved using its subcomponent 102 (an adjustment fastener and or a hook and loop fastener (Velcro®)).

The adjustment of the loop of the Planter Retaining Harness is necessary to accommodate different size, configuration and shape planters. The retaining harness utilizes the taper, and or the rimmed diameter or the rolled top edge of the planter to support the planter in the elevated position.

The Planter Retaining Harness's (104) position relative to the Main Support Harness's (101) encompassed circumference is adjustable along the circumference or otherwise the length of the Main Support Harness 101.

### Figures

Figure I, shows in an auxiliary view the harness and the harness subcomponents in a closed assembled position. 101 Main Support Harness, 102 Connecting and Adjustment Fastener, 103 Adjustable attaching fastener, 104 Planter Retaining Harness, 105 Adjustment Fastener. The Main Support Harness 101 retains the Planter Retaining Harnesses. The Planter Retaining Harnesses are sub components of the main support harness. All secondary components are attached to the main support harness 101 either permanently or made detachable.

(The Planter Retaining Harness) 104 is constructed of a flexible belt, belt like, strap or strap like material and is adjustable via 105 an adjustment fastener and or a hook and loop material (Velcro) unless otherwise constructed to a fixed size or diameter when called for on special production applications. The Planter Retaining Harness is flexible and adjustable similar to a waste line belt thus the area in the center area (the loop)of the Planter Retaining Harness can be adjusted to be smaller or larger, this adjustment is achieved using its subcomponent 102 (an adjustment fastener and or a hook and loop fastener(Velcro).

The adjustment of the loop of the Planter Retaining Harness is necessary to accommodate different size, configuration and shape planters. The retaining harness utilizes the taper, and or the rimmed diameter or the rolled top edge of the planter to support the planter in the elevated position.

The Planter Retaining Harness's (104) position relative to the Main Support Harness's (101) encompassed circumference is adjustable along the circumference or otherwise the length of the Main Support Harness 101.

Figure II, shows in perspective and an auxiliary view the complete harness and the harness subcomponents assembled with planters around the circumference of a tree trunk.

Figure III, is an assembly drawing of the harness and the planters and a drawing of the completed assembly without the tree trunk.

What is claimed is:

1. A method of using a harness system for holding at least one planter in an elevated position comprising:
feeding a first end of a main support harness of a tree planter harness around at least a first side of a periphery of a secondary object,
wherein the tree planter harness comprises,
at least one main support harness having two ends with each of the two ends having a main harness connecting and adjustment fastener,
wherein the two ends are connected via the main harness connecting and adjustment fastener forming a main loop having a first length and
wherein the length of the main loop is adjustable,
wherein the length of the main loop is tensioned against the periphery of the secondary object and utilizes non-conformities of the periphery of the secondary object for added support,
at least one planter retaining harness removably coupled to the at least one main support harness and independently positionable around the main support harness, the at least one planter retaining harness having two ends with each of the two ends having a planter retaining harness complimentary connecting and adjustment fastener,
wherein the two ends are connected via the planter retaining harness connecting and adjustment fastener forming a secondary loop having a second length and
wherein the length of the secondary loop is adjustable,
an adjustable attaching fastener that removably couples the at least one planter retaining harness to the at least one main support harness,
feeding a second end of the main support harness around at least a second side of the periphery of the secondary object;
securing the first end of the main support harness to the second end of the main support harness using the main harness connecting and adjustment fastener on each of the first end and the second end;
adjusting a height of the main support harness around the secondary object;
tightening the main support harness around the periphery of the secondary object;
feeding a first end of a planter retaining harness around at least a first side of a periphery of a planter;
feeding a second end of the planter retaining harness around at least a second side of the periphery of the planter;
securing the first end of the planter retaining harness to the second end of the planter retaining harness using the planter retaining harness connecting and adjustment fastener; and
tightening the planter retaining harness around the periphery of the planter,
wherein the adjustable attaching fastener is oriented to provide an uninterrupted surface between the adjustable attaching fastener and the planter thereby permitting the planter to be flush with the adjustable attaching fastener.

2. The method of claim 1 further comprising the steps of:
feeding a first end of a second planter retaining harness around at least a first side of a periphery of a second planter;
feeding a second end of the second planter retaining harness around at least a second side of the periphery of the second planter;
securing the first end of the second planter retaining harness to the second end of the second planter retaining harness using a second planter retaining harness connecting and adjustment fastener; and
tightening the planter retaining harness around the periphery of the second planter, wherein
the adjustable attaching fastener is oriented to provide an uninterrupted surface between the adjustable attaching fastener and the second planter thereby permitting the planter to be flush with the adjustable attaching fastener.

3. The method of claim 2 wherein the first feeding through the tightening steps are repeated for each additional planter after the second planter.

4. The method of claim 1 wherein the tightening of the main support harness is achieved via the main harness connecting and adjustment fastener.

5. The method of claim 2 wherein there are between about 1 to about 15 planter retaining harnesses and more preferably about 3 to about 9 planter retaining harnesses disposed along the circumference of the main support harness.

6. The method of claim 1 wherein the secondary object is a trunk of a tree.

7. The method of claim 1 wherein there is one planter held by each planter retaining harness.

8. The method of claim 1 wherein the secondary loop has a shorter length than the main loop.
